(19) United States
(12) Patent Application Publication
(10) Pub. No.: US 2023/0375063 A1
(43) Pub. Date: Nov. 23, 2023

(54) VIBRATION ABSORBER WITH DOUBLE MASS

(71) Applicant: Vibracoustic SE, Darmstadt (DE)

(72) Inventors: Thomas Bock, Freiburg (DE); Frank Willin, Ballrechten-Dottingen (DE); Tim Suetterlin, Neuenburg (DE); Frederik Götz, Breisach (DE)

(21) Appl. No.: 18/143,310

(22) Filed: May 4, 2023

(30) Foreign Application Priority Data
May 23, 2022 (DE) 10 2022 112 966.7

(51) Int. Cl. F16F 7/104

(52) U.S. Cl. CPC F16F 7/104; F16F 2222/08; F16F 2230/0005

(57) ABSTRACT

A vibration absorber includes a carrier plate having two sides and a bore, a mass element provided on each of the two sides of the carrier plate to form a mass pair, and a connecting bolt. The connecting bolt projects through the bore and projects on both sides of the carrier plate into the mass elements to fix or connect the mass element on each side of the carrier plate on or to the carrier plate.

### CROSS-REFERENCE TO RELATED APPLICATION

This application claims priority to German Patent Application No. DE 10 2022 112 966.7, filed May 23, 2022, the contents of which are hereby incorporated by reference in its entirety.

### TECHNICAL FIELD

The invention relates to vibration absorbers.

### BACKGROUND

Vibration absorbers which comprise a holding plate that carries an absorber mass are known in practice. The absorber mass is vulcanized onto the holding plate by way of an elastomer body by means of a binder. The holding plate has holes through which pressed-in bolts as a loss prevention device engage in the mass without touching the holding plate. Vibration absorbers which comprise a holding plate that carries an absorber mass on each side in order to be able to set two different natural frequencies are also known in practice. The absorber masses are each vulcanized onto the holding plate by way of an elastomer body by means of a binder. Loss prevention devices are not possible since both sides of the holding plate are covered by means of an absorber mass. The fact that the absorber mass must be inserted into a vulcanization mould results in high costs for production and the moulds. In addition, a loss prevention device must be integrated so that the absorber mass is secured if the rubber breaks. The natural frequency of the vibration absorber can be adjusted only via the hardness of the elastomer (shear modulus). Adjusting the vibration absorber to two frequencies independently of one another is possible only with difficulty.

Vibration absorbers with a screw-fastened absorber mass on the holding plate are also known, as for example in DE 10 2019 104 386 A1. However, the screw connection leads to high production costs.

### SUMMARY

It is therefore an aspect of the invention to provide a vibration absorber which fixes as many absorber masses as possible permanently and in a reliable process with as few components as possible, while being inexpensive to produce.

Features of the invention are disclosed herein.

According to the aspects and teachings, embodiments of a vibration absorber comprise a carrier plate with two sides, which has a bore, and a mass element on each of the sides, the said elements forming a mass pair. The vibration absorber also comprises a connecting bolt, which projects through the bore of the carrier plate and projects on both sides into the mass elements, forming a respective holding connection for fixing the latter on the carrier plate.

Embodiments of the invention provide for two mass elements to be assigned to and held by a single connecting bolt. It is thereby possible to reduce the number of holding elements per mass element mathematically to 0.5 and to reduce the number of components considerably.

By virtue of the fact that the mass elements are arranged on both sides of the carrier plate and only one connecting bolt is provided for the mass pair, an installation space can be utilized in the best possible way. In addition, the mass pair forms a system which can be adjusted to a desired resonant frequency.

By virtue of the fact that the respective holding connection is formed in the corresponding one of the mass elements, no installation space has to be provided outside the mass element for the holding connection. In this way, too, an installation space can be utilized in the best possible way and the vibration absorber can be designed to be as small as possible.

The two sides of the carrier plate can face in opposite spatial directions. The at least one bore in the carrier plate can lead from one side of the carrier plate to the other side of the carrier plate, that is to say can be a through bore. The mass elements can be absorber masses. An absorber mass or a mass element can be part of a mass-spring system, the natural frequency of which can be adjusted to the vibration frequency to be eliminated and serves primarily for absorption. The mass elements can each have a bore into which the connecting bolt projects. The mass elements can be self-contained and/or separate parts and/or complete parts. Therefore, they do not have to form a section of a larger or higher-level mass element. The carrier plate can have a flat carrier section, in which the at least one bore is formed. This ensures a flat geometry for the mass elements, which itself can be produced at low cost and saves installation space. The connecting bolt can have a holding section at each of the two ends, the said holding section forming the holding connection with the corresponding mass element.

A vibration absorber according to this disclosure may be described in an unloaded/unoper-ated state, with reference being made separately to load and operating cases.

According to a conceivable further development of a vibration absorber according to aspects and teachings of the disclosure, the mass pair or each of the mass pairs can be fixed by a single connecting bolt in each case. As a result, as few components as possible can be used. Moreover, mounting of the mass elements on the corresponding connecting bolt is simplified since exact alignment during mounting on a plurality of fixing elements is eliminated.

According to a conceivable further development of the vibration absorber according to aspects and teachings of the disclosure, the connecting bolt can be of integral design. Integral is intended to mean that it is made of one piece. As a result, it is possible to avoid vulnerable joints or connection points.

According to a conceivable further development of the vibration absorber according to aspects and teachings of the disclosure, the at least one connecting bolt can be formed mirror-symmetrically with respect to its transverse centre plane and/or rotationally symmetrically with respect to its central longitudinal axis. The rotational symmetry can be a rotational symmetry in the mathematically narrower sense—a rotation about any desired angle maps the connecting bolt onto itself. The rotational symmetry can alternatively be a rotational symmetry in the mathematically broader sense, where the rotational symmetry can be multi-fold, and the order can be greater than 2. The symmetries simplify installation of the connecting bolt since its installation position is unim-portant. This results in an assembly process that is easy to control. The symmetries also ensure identical absorption behaviour of the two mass elements.

According to a conceivable further development of the vibration absorber according to aspects and teachings of the disclosure, the carrier plate can be produced from a metal or plastic, in particular a thermoplastic or thermoset, and/or the mass elements can be produced from an elasto-meric or metallic material, for example as a vulcanized part or metal casting, and/or the at least one connecting bolt can be produced from a metal or plastic, in particular a thermoplastic or thermoset. The mass elements can be absorber masses.

The advantages of a carrier plate made of the materials mentioned can lie in the fact that it is stiff enough and at the same time sufficiently tough to be able to input and output vibrations on a sustainable basis. The advantages of mass elements made of the materials mentioned lie in the fact that they have a high weight for comparatively low costs, particularly in the case of a metallic material. The advantages of the connecting bolt made of the materials mentioned lie in the fact that high forces can be transmitted thereby, particularly in the case of a metallic connecting bolt. When mass elements of a mass pair made of metal and a connecting bolt made of metal are used, a metal-metal connection which is durable and secure is thus obtained.

According to a further development of the vibration absorber according to aspects and teachings of the disclosure, the holding connections can be screw connections, latched connections and/or press-fit connections. Just one of these two last-mentioned holding connections is also conceivable.

In the case of the screw connection, the at least one connecting bolt can have a thread for each of the holding connections on the outer circumference, for example in the holding section. The thread can engage in a threaded counterpart in the mass element, wherein the threaded counterpart can be a separate part from the mass element. The threaded counterpart can be, for example, a sleeve with an internal thread embedded in the mass element. As a result, the material of the mass element does not have to be suitable for the formation of the thread and for directly absorbing screw-fastening forces emanating therefrom. Alternatively, the thread can project into the respective mass element with a thread-cutting action or with the thread having been cut. As a result, very high pure axial forces (relative to the central longitudinal axis of the connecting bolt) are necessary to release the fixing.

In the case of the latched connection, the at least one connecting bolt can have latching elements, such as latching ramps, or mating latching elements, such as latching grooves for each of the holding connections on the outer circumference, for example in the holding section. The latching elements or mating latching elements can engage in the corresponding counterpart of the latching element and mating latching element in the mass element, or else latching elements can engage in the material of the respective mass element with elastic deformation of the mass element. In the latter case, the mass element has no dedicated counterpart for the latching elements, thus allowing an advantageous combination of non-positive and positive engagement here. As a result, assembly is possible by simply putting the mass element onto the connecting bolt in the axial direction (with respect to the central longitudinal axis of the connecting bolt), while at the same time sufficient security against loss is ensured. Moreover, as a result of the omission of a screw connection and the introduction of a purely axial force there is no risk of torsional rotation of a mass element or torsional prestressing of the material of the mass element.

In the case of the press-fit connection, the at least one connecting bolt for each of the holding connections can have, on the outer circumference, a circumferentially continuous or section-wise surface of revolution and/or longitudinal structures, such as longitudinal teeth or longitudinal webs, for example in the holding section. The surface of revolution can allow a large-area press-fit connection, while the longitudinal structures can engage on the mass element with region-wise elastic deformation of the latter. Overall, a press-fit connection allows very simple assembly since, in particular, no screwing and no vulcanization is necessary. Moreover, as a result of the omission of a screw connection and the introduction of a purely axial force there is no risk of torsional rotation of a mass element or torsional prestressing of the material of the mass element. The longitudinal structures also serve to vent the blind bore in the mass element during pressing. When the mass element is pushed onto the connecting bolt, the air displaced from the blind bore can escape from the blind bore along the longitudinal structures. As a result, a negative overpressure in the blind bore at the end of the connecting bolt and more difficult pressing against this overpressure can be avoided. It is also conceivable that the oversize between the mating surfaces of the connecting bolt (holding section) and the mass elements is so small that the press-fit connection can be produced, for example, exclusively by pressing in longitudinally, it being possible for the two components to be joined by means of a press. Excessive oversize can be eliminated since the press-fit connection can no longer be produced solely by means of a press-in pressure. Methods used for this purpose, such as shrinking and expansion, are not necessary from the point of view of service life and safety.

According to a further development of the vibration absorber according to aspects and teachings of the disclosure, a respective spring device, preferably a spring washer, can be arranged between each mass element of a mass pair and the carrier plate. The corresponding mass element can thus be coupled directly via the spring device and the carrier plate and in a manner capable of vibration to a vehicle part to be damped. If the vehicle part connected to the vibration absorber begins to oscillate, the mass element also oscillates with a certain delay, with damping of the os-cillations taking place via the spring device. It is conceivable that the spring device is an elasto-meric spring device. Moreover, the spring device arranged there can space the respective mass element apart from the carrier plate. Abutment of the spring device against the carrier plate can thus be ruled out and free vibration of the mass elements can be made possible during operation.

According to a conceivable further development of the vibration absorber according to aspects and teachings of the disclosure, the mass elements cannot rest against or touch the carrier plate. Here, the spring elements and/or the corresponding connecting bolt can be the, preferably only, interposed component(s) between the respective mass element and the carrier plate, i.e. the mass elements can output vibrations to the carrier plate and/or absorb them exclusively via the spring elements. Advantageously, the corresponding connecting bolt likewise cannot rest against the carrier plate or touch it. It is conceivable that the corresponding connecting bolt is connected exclusively to the mass elements of the mass pair or additionally to the spring elements, for example by contact. This arrangement improves free vibration of the mass elements during operation.

According to a conceivable further development of the vibration absorber according to aspects and teachings of the disclosure, the spring devices can be free of a materially bonded connection, that is to say free of material bonding. Therefore, the respective spring device is not materially bonded to a further component, for example by means of vulcanization. As a result, a modular design is possible since a desired frequency can be set by simply replacing the spring device by another spring device with different absorption properties.

According to a conceivable further development of the vibration absorber according to aspects and teachings of the disclosure, the two spring devices of a mass pair can be identical. This enables the mass pair to be adjusted very well to a frequency to be absorbed, it being possible for example for an outside diameter, an inside diameter, an axial thickness and/or a choice of material to serve as parameters for this purpose. In the case of a plurality of mass pairs, it is conceivable for the two spring devices of a mass pair to be identical but for each mass pair to have different spring devices. It is thereby possible to damp a plurality of frequencies in an advantageous manner with just a single vibration absorber.

According to a conceivable further development of the vibration absorber according to aspects and teachings of the disclosure, the two spring devices of a mass pair can project into the bore of the carrier plate. It is thereby possible to prevent slippage of the spring devices transversely to the central longitudinal axis of the connecting bolt. The inward projection can take place by means of an annular flange extending in the axial direction (with respect to the central longitudinal axis of the connecting bolt) and/or by means of elastic deformation of the spring devices. In the case of a flat spring device, for example, the said inward projection can take place in that the holding connection produces an axially acting preload which deforms the spring devices at least in some section or sections into the bore of the carrier plate. As a result, positive engagement can occur between the bore edge and the spring device. For this purpose, the diameter of a bore in the spring device is preferably smaller than the diameter of the bore in the carrier plate.

According to a further development of the vibration absorber according to aspects and teachings of the disclosure, the spring devices can each have a bore which can rest in a radially centred manner against the connecting bolt. The bores can also each have a supporting flange on the inner circumference, which can rest in a radially centred manner against the connecting bolt. The supporting flange can extend radially inwards. As a result, the spring device can be held by the connecting bolt and at the same time arranged centrally with respect to the holding connection. This results in advantageous and uniform absorber behaviour. This enables the respective spring device to be arranged in a space-saving manner, and it does not require any separate fixing devices. The spring device can be fixed by the connecting bolt. This bore can be a through bore.

According to a further development of the vibration absorber according to aspects and teachings of the disclosure, the mass elements of the mass pair and/or the connecting bolt of the mass pair and/or the spring devices of the mass pair can be designed and/or arranged mirror-symmetrically with respect to the carrier plate. The section of the carrier plate which has the bore can be the reference. This results in advantageous and uniform absorber behaviour. The same can apply to a plurality of mass pairs. Therefore, mass elements can be provided on both sides of the carrier plate, and during operation these ensure a uniform, at times linear, movement and can thus prevent wobbling.

According to a conceivable further development of the vibration absorber according to aspects and teachings of the disclosure, the mass elements of a mass pair or the mass elements of all the mass pairs can be identical, in particular in respect of material and geometry. As a result, identical parts can be used here, thereby making it possible to reduce production and assembly costs since their installation position can be independent of their geometry.

According to a further development of the vibration absorber according to aspects and teachings of the disclosure, the mass elements of the mass pair can be designed without a through bore and/or can each have a blind bore into which the connecting bolt projects. Such a blind bore protects the connecting bolt from environmental influences by virtue of the fact that the bore is only open at one end. Environmental influences can be, for example, dust and moisture. This makes it possible to dispense with corresponding surface protection of the connecting bolt in this region. The same can apply to a plurality of mass pairs.

According to a further development of the vibration absorber according to aspects and teachings of the disclosure, the carrier plate and/or the mass elements of a mass pair and/or the spring devices of a mass pair can form a closed interior space, in which the connecting bolt is arranged. Such an interior space protects the connecting bolt from environmental influences by virtue of the fact that it is embedded or surrounded by one or more elements and is separated from the environment. Environmental influences can be, for example, dust and moisture. This makes it possible to dispense with corresponding surface protection of the entire connecting bolt. In addition, only a few components are required to limit this interior space and at the same time to ensure the absorber function.

According to a further development of the vibration absorber according to aspects and teachings of the disclosure, the mass elements of the mass pair can be designed and/or arranged rotationally symmetrically with respect to the corresponding connecting bolt. The connecting bolt can therefore advantageously engage in a central point of the respective mass element, for example the connecting bolt can engage in a surface centre of that side of the mass element which faces the carrier plate. The rotational symmetry can be a rotational symmetry in the mathematically narrower sense—a rotation about any desired angle maps the mass element onto itself. The rotational symmetry can alternatively be a rotational symmetry in the mathematically broader sense, where the rotational symmetry can be multi-fold, and the order can be greater than 2, preferably being precisely 4. By means of this symmetry, unwanted loads and vibrations of the mass elements and spontaneous release due to non-central engagement of the connecting bolt can be avoided. In addition, the mass elements can be produced as identical parts since their installation position can be independent of their geometry.

According to a further development of the vibration absorber according to aspects and teachings of the disclosure, the connecting bolt of the mass pair can in each case have a positioning shoulder for each mass element of the mass pair. A positioning shoulder can be a sectional or continuous diameter step arranged on the outer circumference, wherein a contact surface of the positioning shoulder can face the corresponding mass element. The positioning shoulder can de-fine an axial end position of the respective mass element on the connecting bolt. By means of the positioning shoulders, it is furthermore possible to set a spacing of the mass elements of a mass pair with respect to one another in a structurally simple manner. Precise setting of the natural frequency can thus be achieved via the spacing between the mass elements of a mass pair.

According to a further development of the vibration absorber according to aspects and teachings of the disclosure, a further mass element can be arranged on each of the sides, the said elements forming a further mass pair. The features disclosed here can apply in an identical manner to this mass pair. It is therefore conceivable to arrange two or more identical mass pairs on the one carrier plate, as well as a plurality of different designed mass pairs. For this further mass pair, the carrier plate can comprise a further bore. The vibration absorber can also comprise a further connecting bolt for this further mass pair, the said bolt projecting through the further bore and projecting on both sides into the further mass elements, forming a respective holding connection for fixing the latter on the carrier plate. By means of this further mass pair, the vibration absorber can also be designed to absorb a further resonant frequency.

According to a conceivable further development of the vibration absorber according to aspects and teachings of the disclosure, the mass elements of adjacent mass pairs can be fully spaced apart from one another. As a result, these mass elements do not rest against one another and do not hinder the respective free vibration of the mass elements during operation.

According to a conceivable further development of the vibration absorber according to aspects and teachings of the disclosure, the at least one connecting bolt can have three regions directly adjoining one another on both sides of its transverse centre plane, namely a contact section close to the transverse centre plane, the positioning shoulder adjoining it in the axial direction, and the holding section adjoining the latter in the axial direction. This allows compact configuration of the connecting bolt. The contact section can have the largest outside diameter and/or rest against the spring device and/or be arranged in the bore of the carrier plate.

Further features, details and advantages of the invention will be apparent from the wording of the claims and from the following description of exemplary embodiments with reference to the drawings. In the drawings:

### BRIEF DESCRIPTION OF THE DRAWINGS

FIG. 1 shows an exploded illustration of a vibration absorber according to aspects and teachings of the disclosure;

FIG. 2 shows the vibration absorber according to FIG. 1 in a sectional view, and

FIG. 3 shows a detail view from FIG. 2.

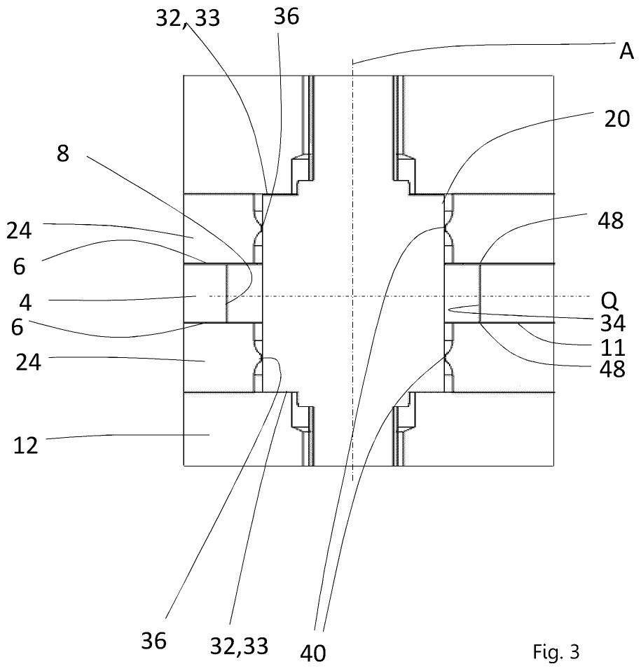

### DETAILED DESCRIPTION

In the figures, elements which are identical or correspond to one another are each designated by the same reference signs and are therefore not described again, unless it is expedient to do so. Features already described are not described again in order to avoid repetitions and they are applicable to all elements with the same or mutually corresponding reference signs, unless explic-itly excluded. The disclosures contained in the description as a whole can be applied analogously to identical parts with the same reference signs or the same component designations. The position information chosen in the description, such as, for example, top, bottom, side, etc. also relates to the directly described and illustrated figure and should be applied mutatis mutandis to the new position in the event of a change in position. Furthermore, individual features or combinations of features from the different exemplary embodiments shown and described can also represent independent solutions that are inventive or according to aspects and teachings of the disclosure.

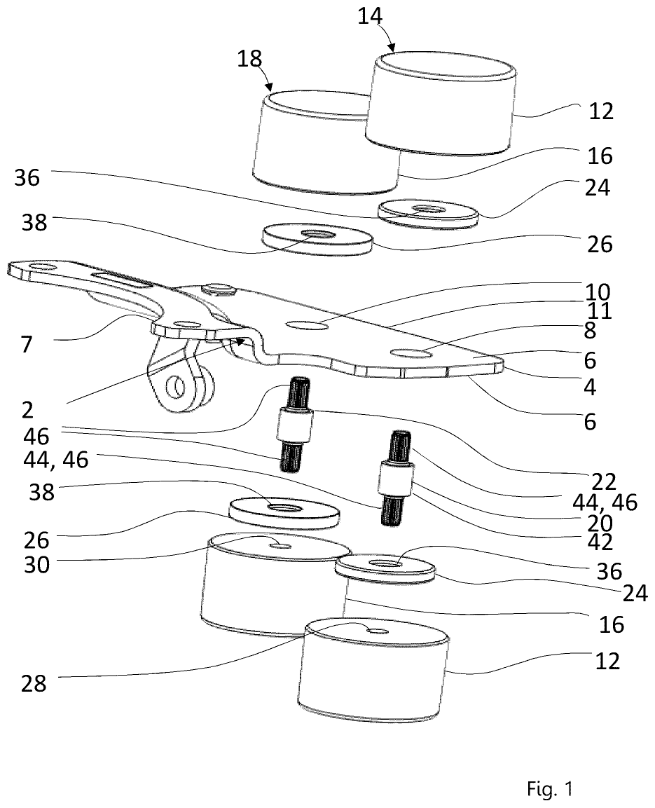

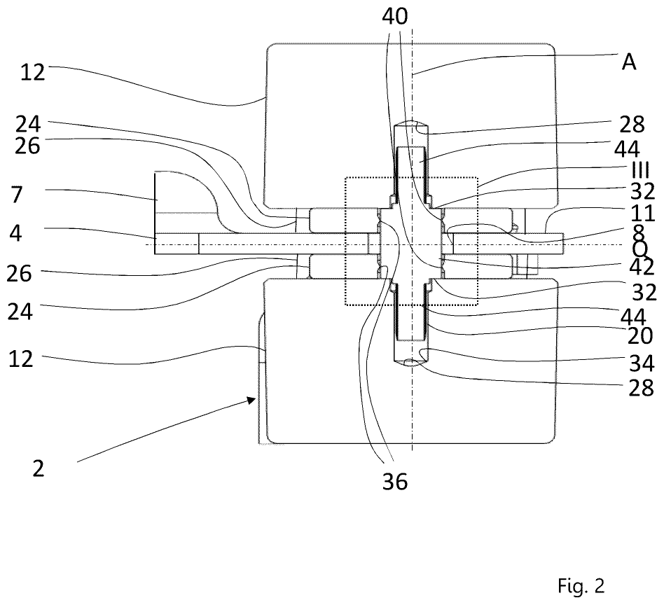

FIG. 1 shows an exploded illustration of the individual components of a vibration absorber 2, this vibration absorber 2 being shown after assembly in FIG. 2.

The vibration absorber 2 comprises a carrier plate 4 which has two sides 6 that face in opposite spatial directions. The carrier plate 4 comprises an attachment geometry 7 (not designated specifically) for attaching the vibration absorber 2 to a component to be damped. In addition, the carrier plate 4 comprises two bores 8, 10, which lead from one side 6 of the carrier plate 4 to the other side 6 of the carrier plate 4, that is to say are through bores. The two bores 8, 10 are formed in a flat carrier section 11 of the carrier plate 4.

The vibration absorber 2 also comprises two mass pairs 14, 18. Each of the mass pairs 14, 18 comprises two mass elements 12, 16, which are absorber masses. One of the mass elements 12, 16 of each of the mass pairs 14, 18 is arranged on one of the two sides 6. The mass elements 12, 16 of the adjacent mass pairs 14, 18 are arranged fully spaced apart from one another. The mass elements 12, 16 each have a bore, which is designed as a blind bore 28, 30. In the present case, the four mass elements 12, 16 are identical. They are also designed and arranged mirror-symmetrically with respect to the carrier plate 4 or the carrier section 11. They are furthermore designed and arranged in a rotationally symmetrical manner (order=4) with respect to a corresponding connecting bolt 20, 22.

The vibration absorber 2 also comprises a one-piece connecting bolt 20, 22 for each of the two mass pairs 14, 18. In the assembled state, connecting bolt 20 projects through bore 8 of the carrier plate 4 and into blind bores 28 of mass elements 12. In the assembled state, connecting bolt 22 projects through bore 10 of the carrier plate 4 and into blind bores 30 of mass elements 16. The connecting bolts 20, 22 do not rest directly against the carrier plate 4 or touch it. In the blind holes 28, 30, the respective mass elements 12, 16, together with the respective connecting bolt 20, 22, form a holding connection in the form of a press-fit via holding sections 44. Thus, the mass elements 12, 16 are fixed on the carrier plate 4 by means of a single connecting bolt 20, 22 in each case. The connecting bolts 20, 22 are of identical configuration and are mirror-symmetrical with respect to their respective transverse centre plane Q and rotationally symmetrical in the mathematically broader sense with respect to their respective central longitudinal axis A. Each of the connecting bolts 20, 22 has a contact section 42 on both sides of its transverse centre plane Q, the said contact sections having the largest diameter. Adjoining this in the axial direction is a positioning shoulder 32. Adjoining this in the axial direction is the holding section 44. The connecting bolts 20, 22 of the mass pairs are designed and arranged mirror-symmetrically with respect to the carrier plate 4. Each of the positioning shoulders 32 has a contact surface 33 and is designed as a continuous diameter step arranged on the outer circumference. The contact surface 33 of the positioning shoulder 32 faces the corresponding mass element 12, 16, wherein the mass element 12, 16 rests against this positioning shoulder 32. It can be seen that each holding section 44 has longitudinal structures in the form of longitudinal teeth 46. These longitudinal teeth 46 press into the material of the respective mass element 12, 16 to provide non-positive and positive engagement. Adjacent longitudinal teeth 46 are spaced apart in the circumferential direction by longitudinal grooves.

The vibration absorber 2 furthermore comprises a spring device in the form of a spring washer 24, 26 for each mass element 12, 16 of the two mass pairs 14, 18. The spring washers 24, 26 are separate parts and are arranged without material bonding. The spring washers 24, 26 are arranged between the corresponding mass element 12, 16 and the carrier plate 4. Therefore, the mass elements 12, 16 do not rest against or touch the carrier plate 4. The spring washers 24, 26 each have a bore 36, 38, through which the corresponding connecting bolt 20, 22 extends. The bores 36, 38 of the spring washers 24, 26 each have a supporting flange 40 on the inner circumference, which rests in a radially centred manner against the connecting bolt. The spring washers 24, 26 of each mass pair 14, 18 are of identical design and are designed and arranged mirror-symmetrically with respect to the carrier plate 4 or the carrier section 11. However, each mass pair 14, 18 has different spring washers 24, 26. More specifically, the two spring washers 24 of mass pair 14 have a smaller outside diameter than the two spring washers 26 of mass pair 18. As a result, the mass pairs 14, 18 damp different frequencies. The spring washers 24, 26 each have an inside diameter which is smaller than the diameter of the bores 8, 10 of the carrier plate 4. The spring washers 24, 26 therefore project into the bores 8, 10, since they are preloaded by the mass elements 12, 16 in such a way that they are elastically deformed into the respective bores 8, 10 in the region of the inside diameter. As a result, positive engagement can occur between a bore edge 48 of the respective bore 8, 10 and the respective spring washer 24, 26.

The carrier plate 4, the mass elements 12, 16 of each mass pair 14, 18 and the spring washer 24, 26 of each mass pair 14, 18 form an interior space 34 which is closed off from the environment. The respective connecting bolt 20, 22 is arranged in the interior space 34.

The invention is not limited to one of the above-described embodiments but can be modi-fied in a variety of ways. All of the features and advantages emerging from the claims, the description and the drawing, including structural details, spatial arrangements and method steps, may be essential to the invention both individually and in a wide variety of combinations.

All combinations of at least two of the features disclosed in the description, the claims and/or the figures fall within the scope of the invention.

In order to avoid repetitions, features disclosed in terms of a device are also to be regarded as disclosed and claimable in terms of a method. Likewise, features disclosed in terms of a method are to be regarded as disclosed and claimable in terms of a device.

1. A vibration absorber, comprising:
a carrier plate having two sides, the carrier plate including a bore,
a mass element on each of the two sides, the mass element on each of the two sides forming a mass pair, and
a connecting bolt,
wherein the connecting bolt projects through the bore on each of the two sides of the carrier plate and into the mass element on each of the two sides of the carrier plate to form a respective holding connection to fix or connect the mass elements on or to the carrier plate.

2. The vibration absorber according to claim 1, wherein the holding connections are screw connections, latched connections and/or press-fit connections.

3. The vibration absorber according to claim 1, wherein a spring device is arranged between each mass element of the mass pair and the carrier plate.

4. The vibration absorber according to claim 3, wherein the spring device comprises a spring washer.

5. The vibration absorber according to claim 3, wherein the spring devices each have a spring bore that rests in a radially centred manner against the connecting bolt, or the spring bores each have a supporting flange on an inner circumference that rests in a radially centred manner against the connecting bolt.

6. The vibration absorber according to claim 1, wherein the mass elements of the mass pair and/or the connecting bolt of the mass pair and/or the spring devices of the mass pair are designed and/or arranged mirror-symmetrically with respect to the carrier plate.

7. The vibration absorber according to claim 1, wherein the mass elements of the mass pair are designed without a through bore and/or each have a blind bore into which the connecting bolt projects.

8. The vibration absorber according to claim 1, wherein the carrier plate and/or the mass elements of the mass pair and/or the spring devices of the mass pair form/forms a closed interior space, in which the connecting bolt is arranged.

9. The vibration absorber according to claim 6, wherein the mass elements of the mass pair are designed and/or arranged rotationally symmetrically with respect to the corresponding connecting bolt.

10. The vibration absorber according to claim 1, wherein the connecting bolt of the mass pair has a positioning shoulder for each mass element of the mass pair.

11. The vibration absorber according to claim 1, wherein a second mass element is arranged on each of the two sides of the carrier plate, the second mass elements forming a second mass pair.
